(19) United States
(12) Patent Application Publication
(10) Pub. No.: US 2008/0117273 A1
(43) Pub. Date: May 22, 2008

(54) Image recording device and image recording method

(75) Inventors: Kunichi Yamashita, Kanagawa (JP); Takashi Ogino, Kanagawa (JP); Ken Hashimoto, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/890,576

(22) Filed: Aug. 7, 2007

(30) Foreign Application Priority Data
Nov. 16, 2006 (JP) 2006-310114
Nov. 16, 2006 (JP) 2006-310115

(51) Int. Cl. B41J 2/17; B41J 2/01

(52) U.S. Cl. 347/96; 347/101

(57) ABSTRACT

An image recording device includes a processing solution-supplying unit that supplies, to a recording medium, a processing solution; an ink-ejecting unit that ejects ink to the recording medium; and an energy supplying unit that supplies energy to the recording medium, wherein the processing solution contains a polybasic acid having two or more groups reactive with components constituting the recording medium in a molecule.

### CROSS-REFERENCE TO RELATED APPLICATIONS

This application is based on and claims priority under 35 USC 119 from Japanese Patent Application Nos. 2006-310114 and 2006-310115 filed Nov. 16, 2006.

### BACKGROUND

1. Technical Field

The present invention relates to an image recording device and an image recording method of recording an image on a recording medium such as paper by using ink.

2. Related Art

An inkjet recording system has been attracting attentions, as it has many advantages that it allows full color printing easily, consumes less energy, do not generate noise during recording, and provides printers at a lower production cost.

Recently in a trend toward further increase in image quality, speed, and reliability of the process, images and characters are more frequently printed on plain paper, and thus it is quite important to raise the recording compatibility with plain paper. So-called aqueous ink containing water as the principal component has been widely used as the ink for use in such an inkjet recording system, favorably from the viewpoint of safety. However, because the water in ink interacts with paper fiber, the aqueous ink often leads to curling and deterioration in stiffness of the paper, troubles such as paper clogging in printer, abrasion of image region, and stacking trouble in a paper discharge unit are caused. In particular, when a high-recording-density image is printed, the aqueous ink often causes a problem of enhanced curling after storage and drying. Thus, there is still a need for improvement in the curling resistance and stiffness of paper.

Under the circumstances above, methods for reducing the curling in an inkjet recording system using an aqueous ink have been studied.

### SUMMARY

According to a first aspect of the invention, there is provided an image recording device including a processing solution-supplying unit that supplies a processing solution to a recording medium, an ink-ejecting unit that ejects ink to the recording medium, and an energy supplying unit that supplies energy to the recording medium, wherein the processing solution contains a polybasic acid having in a molecule two or more groups reactive with a component of the recording medium.

According to a second aspect of the invention, there is provided an image recording device including an ink-ejecting unit that ejects an ink onto a recording medium, and an energy supplying unit that supplies energy to the recording medium, wherein the ink contains a colorant and a polybasic acid having in a molecule two or more groups reactive with a component of the recording medium.

### BRIEF DESCRIPTION OF THE DRAWINGS

Exemplary embodiments of the present invention will be described in detail based on the following figures, wherein:

FIG. 1 is a perspective view illustrating an example of an ink-ejecting unit in an exemplary embodiment of the invention;

FIG. 2A is a schematic sectional view illustrating a heating roller as an energy-supplying unit in an exemplary embodiment of the invention;

FIG. 2B is a schematic sectional view illustrating a coil in the heating roller shown in FIG. 2A;

FIG. 3 is a schematic sectional view illustrating a microwave-irradiating device used as the energy-supplying unit in an exemplary embodiment of the invention;

FIG. 4 is a schematic sectional view illustrating an exemplary embodiment of an image recording device of the invention;

FIG. 5 is a schematic sectional view illustrating an exemplary embodiment of the image recording device of the invention;

FIG. 6 is a schematic sectional view illustrating an exemplary embodiment of the image recording device of the invention; and

FIG. 7 is a schematic sectional view illustrating an exemplary embodiment of the image recording device of the invention.

### DETAILED DESCRIPTION

—Image Recording Device and Image Recording Method—

The image recording device in a first aspect of the invention characteristically has a processing solution-supplying unit that supplies, to a recording medium, a processing solution containing a polybasic acid having in a molecule two or more groups reactive with a component of the recording medium, an ink-ejecting unit that ejects ink to the recording medium, and an energy supplying unit that supplies energy to the recording medium. The processing solution may be supplied to any one side or both sides of paper.

The image recording device in a second aspect of the invention characteristically has an ink-ejecting unit that ejects, onto a recording medium, an ink containing a colorant and a polybasic acid having in a molecule two or more groups reactive with a component of the recording medium; and an energy supplying unit that supplies energy to the recording medium.

Hereinafter, the exemplary embodiment of the invention will be described in detail; the processing solution and the ink for use in the exemplary embodiment of the invention will be described first, and then the image recording device and the image recording method will be described. The recording medium may be referred to simply as “paper”, and the components constituting the recording medium, simply as “paper components”.

—Processing Solution—

(Polybasic Acid)

The processing solution used in the image recording device in the first aspect of the invention and in the image recording method in the first aspect of the invention described below is a colorless or light-colored liquid composition containing a polybasic acid having in a molecule two or more groups interactive with paper components. The “group interactive with the paper components” is a group interactive or chemically reactive with the paper components. Specifically, when a paper component has hydroxyl groups, the group is a group interactive with the hydroxyl group by hydrogen-bonding force or chemically reactive with the hydroxyl group.

Examples of the groups interactive with the paper components include a carboxyl group and hydroxyl groups, and the like. Among them, a carboxyl group is particularly preferable, and the polybasic acid according to the exemplary embodiment of the invention is particularly preferably a polybasic acid having three or more carboxyl groups in the molecule.

The mechanism for improvement in curling resistance and stiffness of the paper is yet to be understood, but seems to operate as follows:

In a recording medium (paper) such as pulp paper, the hydroxyl groups contained in the cellulose structure, the principal component in paper, interact with each other by hydrogen-bonding force. When printing is performed by using an aqueous ink, water penetrates into the hydrogen bonds among cellulose molecules in paper, causing phase change of the hydrogen-bonding region and consequently deformation and deterioration in stiffness of the paper. However, it seems possible to crosslink the fibers to each other effectively and to prevent the deformation and deterioration in stiffness of the paper by penetration of water, by supplying a processing solution containing a polybasic acid having two or more groups interactive with the paper components in the molecule to the paper and by supplying energy from outside. In particular, when a processing solution containing a polybasic acid having two or more carboxyl groups in the molecule is used, the carboxyl groups and the hydroxyl groups in paper react with each other in esterification reaction. Accordingly, it seems possible to improve the stiffness and resistance to curling of the paper.

The polybasic acid is preferably a polycarboxylic acid or the salt thereof, and examples thereof include citric acid, 1,2,3,4-butanetetracarboxylic acid, 1,2,3-propanetricarboxylic acid, oxydisuccinic acid, tartarate disuccinic acid, carboxyethylthiosuccinic acid, carboxymethylthiosuccinic acid, maleic acid, fumaric acid, polymer polycarboxylate and the like. Alternatively, the acid anhydride thereof prepared by heating the polybasic acid above may be used instead.

Among the examples above, acids having three or more carboxyl groups such as citric acid, 1,2,3,4-butanetetracarboxylic acid, 1,2,3-propanetricarboxylic acid, oxydisuccinic acid, tartarate disuccinic acid, carboxyethylthiosuccinic acid, and carboxymethylthiosuccinic acid are more preferable, and citric acid and 1,2,3,4-butanetetracarboxylic acid are particularly preferable from the viewpoints of cost and stability.

The amount of the polybasic acid added to the processing solution according to the exemplary embodiment of the invention is preferably 0.2 to 80 weight %, or about 0.2 to about 80 weight %, more preferably 1 to 50 weight %, or about 1 to about 50 weight %, with respect to the total weight of the processing solution. When an addition amount of the polybasic acid is about 0.2 weight % or more, favorable curling resistance is obtained, and when an addition amount of the polybasic acid is about 80 weight % or less, favorable efficiency in supplying the processing solution to paper (for example, coatability) is obtained.

(Other Components)

The processing solution according to the exemplary embodiment of the invention is not particularly limited as long as it contains the polybasic acid, but preferably contains substantially no colorant (transparent) and may contain the components below.

The processing solution according to the exemplary embodiment of the invention preferably contains water, a water-soluble organic solvent, and a surfactant as the principal components.

Examples of the water-soluble organic solvents for use in the exemplary embodiment of the invention include polyvalent alcohols such as ethylene glycol, diethylene glycol, propylene glycol, butylene glycol, triethylene glycol, 1,5-pentanediol, 1,2,6-hexanetriol, and glycerol; polyvalent alcohol derivatives such as ethylene glycol monomethylether, ethylene glycol monoethylether, ethylene glycol monobutylether, diethylene glycol monomethylether, diethylene glycol monoethylether, diethylene glycol monobutylether, diethylene glycol monohexylether, triethylene glycol monobutylether, propylene glycol monobutylether, and dipropylene glycol monobutylether; nitrogen-containing solvents such as pyrrolidone, N-methyl-2-pyrrolidone, and cyclohexylpyrrolidone; alcohols such as ethanol, isopropyl alcohol, butyl alcohol, and benzyl alcohol; sulfur-containing solvents such as thiodiethanol, thiodiglycerol, sulfolane, and dimethylsulfoxide; propylene carbonate; ethylene carbonate, and the like.

These water-soluble organic solvents may be used by itself or in a combination of two or more thereof. The content of the water-soluble organic solvent in the processing solution is not particularly limited, but preferably about 1 to about 60 weight %, more preferably about 5 to about 40 weight %, with respect to the total weight of the processing solution.

In the exemplary embodiment of the invention, a cationic surfactant, a nonionic surfactant, and an anionic surfactant, and the like may be preferably added to the processing solution, for example, for adjustment of the surface tension and the wetting characteristic of the processing solution or for solubilization of organic impurities and improvement in reliability of ink ejection from the nozzle in the ink-ejecting unit (for example, recording head). These surfactants may be used by itself or in a combination of two or more thereof. The amount of the surfactant added to the processing solution is preferably about 5 weight % or less, more preferably about 0.01 to about 3 weight %, with respect to the total weight of the processing solution.

In addition to the components above, other additives including other water-soluble polymers such as polyethyleneimine, polyvinylpyrrolidone, polyethylene glycol, and cellulose derivatives (such as ethylcellulose and carboxymethylcellulose); polymer emulsions such as acrylic polymer emulsion and polyurethane-based emulsion; cyclodextrin, macrocyclic amines, dendrimers, crown ethers, urea and the derivatives thereof, acetamides, and the like may be added to the processing solution according to the exemplary embodiment of the invention for control of the properties of the processing solution.

An alkali metal compound such as potassium hydroxide, sodium hydroxide, or lithium hydroxide; an alkali-earth metal compound such as calcium hydroxide; an acid such as sulfuric acid, hydrochloric acid, or nitric acid; a salt of a strong acid and a weak alkali such as ammonium sulfate; or the like may be added to the processing solution according to the exemplary embodiment of the invention for control of conductivity and pH.

Other additives such as pH buffer, antioxidant, fungicide, viscosity modifier, conductive agent, ultraviolet absorbent, chelating agent, water-soluble dyes, disperse dyes, and oil soluble dye may be added as needed.

Any one of known liquid coating unit may be used as the method of supplying the processing solution according to the exemplary embodiment of the invention on paper. Among them, ejection by an ink-ejecting unit (for example, recording head), roller coating, blade coating, screen coating, and spray coating are favorable, from the viewpoints of uniformity and stability of coating. These methods will be described below in detail.

The processing solution may be supplied to at least one side of the paper, but preferably to both sides, from the viewpoints of more significant improvement in curling resistance and improvement in stiffness.

(Function or Component for Aggregation and/or Thickening of Ink)

The processing solution used in the image recording device in the first aspect of the invention and the image recording method in the first aspect of the invention described below may be a processing solution having a “function to aggregate and/or thicken ink” by containing a component for aggregating and/or thickening ink.

In the image recording device in the second aspect of the invention and the image recording method in the second aspect of the invention described below, the following ink containing the polybasic acid and a processing solution containing a component for aggregating and/or thickening ink may be ejected together, respectively on the surface of paper.

The processing solution having a function or component to aggregate and/or thicken the ink (hereinafter, may be referred to as “aggregating processing solution”) is preferably a processing solution containing water, a water-soluble organic solvent, and a surfactant as its primary components. Any one of known ink components used for aggregating and/or thickening ink (ink coagulant) may be used, as properly selected according to the kind of colorant contained in the ink.

For example, an electrolyte compound or a cationic compound and the like is preferably used as the ink coagulant for inks containing a colorant having anionic groups on the surface.

Examples of the electrolyte components of the electrolyte compound include alkali metal ions such as lithium ion, sodium ion, and potassium ion; polyvalent metal ions such as aluminum ion, barium ion, calcium ion, copper ion, iron ion, magnesium ion, manganese ion, nickel ion, tin ion, titanium ion, and zinc ion; inorganic acids such as hydrochloric acid, hydrobromic acid, hydroiodic acid, sulfuric acid, nitric acid, phosphoric acid, and thiocyanic acid; organic carboxylic acids such as acetic acid, oxalic acid, lactic acid, fumaric acid, citric acid, salicylic acid, and benzoic acid; organic sulfonic acids, the salts thereof, and the like.

Specific examples of the ink coagulants containing the electrolyte component described above include alkali metal salts such as lithium chloride, sodium chloride, potassium chloride, sodium bromide, potassium bromide, sodium iodide, potassium iodide, sodium sulfate, potassium nitrate, sodium acetate, potassium oxalate, sodium citrate, and potassium benzoate; polyvalent metal salts such as aluminum chloride, aluminum bromide, aluminum sulfate, aluminum nitrate, aluminum sodium sulfate, aluminum potassium sulfate, aluminum acetate, barium chloride, barium bromide, barium iodide, barium oxide, barium nitrate, barium thiocyanate, calcium chloride, calcium bromide, calcium iodide, calcium nitrite, calcium nitrate, calcium dihydrogen phosphate, calcium thiocyanate, calcium benzoate, calcium acetate, calcium salicylate, calcium tartarate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, manganese nitrate, magnesium acetate, magnesium lactate, manganese chloride, manganese sulfate, manganese nitrate, manganese dihydrogen phosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, and zinc acetate; and the like.

The cationic compound includes a primary, secondary, tertiary or quaternary amine, the salt thereof, or the like.

Specific examples of the ink coagulant of cationic compound include tetraalkylammonium salts, alkylamine salts, benzalkonium salts, alkylpyridium salts, imidazolium salts, polyamines, and the like, and examples thereof include isopropylamine, isobutylamine, t-butylamine, 2-ethylhexylamine, nonylamine, dipropylamine, diethylamine, trimethylamine, triethylamine, dimethylpropylamine, ethylenediamine, propylenediamine, hexamethylenediamine, diethylenetriamine, tetraethylenepentamine, diethanolamine, diethylethanolamine, triethanolamine, tetramethylammonium chloride, tetraethylammonium bromide, dihydroxyethylstearylamine, 2-heptadecenyl-hydroxyethylimidazoline, lauryldimethylbenzylammonium chloride, cetylpyridinium chloride, stearamidomethylpyridium chloride, diallyldimethylammonium chloride polymer, diallylamine polymer, monoallylamine polymer and the like.

Among the ink coagulants described above, more preferable are aluminum sulfate, calcium chloride, calcium nitrate, calcium acetate, magnesium chloride, magnesium nitrate, magnesium sulfate, magnesium acetate, tin sulfate, zinc chloride, zinc nitrate, zinc sulfate, zinc acetate, aluminum nitrate, monoallylamine polymer, diallylamine polymer, diallyldimethylammonium chloride polymer and the like.

On the other hand, an ink coagulant such as an anionic compound is preferably used for an ink containing a colorant having cationic groups on the surface.

Examples of the anionic compound include an organic carboxylic acid, an organic sulfonic acid, the salt thereof, and the like. Specific examples of the organic carboxylic acids include acetic acid, oxalic acid, lactic acid, fumaric acid, citric acid, salicylic acid, benzoic acid, and the like. And examples of the organic carboxylic acids also include the oligomers and polymers containing a plurality of such basic structures. Examples of the organic sulfonic acids include compounds such as benzenesulfonic acid and toluenesulfonic acid, and also include the oligomers and polymers containing a plurality of such basic structures.

The ink coagulant contained in the processing solution having agglomerating property may be a single coagulant or a mixture of two or more coagulants. The content of the ink coagulant in the processing solution having agglomerating property is preferably in the range of about 0.1 to about 15 weight %, more preferably about 0.5 to about 10 weight %.

The processing solution having agglomerating property for use in the exemplary embodiment of the invention may contain one or more selected from water-soluble polymers, water-soluble oligomers, resin emulsions, and inorganic oxides.

Examples of the resin emulsions include acryl-based resins, vinyl acetate-based resins, styrene-butadiene-based resins, acryl-styrene-based resins, butadiene-based resins, styrene-based resins, polyurethane-based resins, polyolefin-based resins, polyester-based resins, poly-amide-based resins, melamine-based resins, urea-based resins, silicone-based resins, fluorine-based resins, polybutene-based resins, various waxes, and the like. Examples of commercially available emulsions include an acryl-based resin emulsion (trade name: Boncoat 4001, manufactured by Dainippon Ink and Chemicals, Incorporated), styrene-acrylic resin emulsion (trade name: Boncoat 5454, manufactured by Dainippon Ink and Chemicals, Incorporated), J-74J and J-734 (manufactured by Johnson Polymer, Inc.), and the like. However, the exemplary embodiment of the invention is not limited to these examples.

The resin emulsion may be prepared, for example, by pulverization and dispersion of a resin or a wax mechanically in an aqueous medium or by direct polymerization of particles such as emulsion polymerization, dispersion polymerization, or suspension polymerization. In an exemplary embodiment of the invention, the resin may be preferably a polymer having both a hydrophilic region and a hydrophobic region. The particle shape may be spherical or else. The emulsion polymerization, if used, may be carried out in the absence or presence of an emulsifier.

Examples of the inorganic oxides include a high-molecular-weight silicic anhydride (SiO₂), alumina (Al₂O₃) and the like. however, the exemplary embodiment of the invention is not limited to these examples.

The volume-average particle diameter of the resin emulsion or the inorganic oxide colloid is preferably in the range of about 10 nm to about 2 μm, more preferably in the range of about 50 to about 500 nm. A volume-average particle diameter of about 2 μm or less is effective in making the ejection stability in case of ejecting the processing solution from the ink-ejecting unit and the stability during storage favorable. A volume-average particle diameter of 10 nm or more is effective, for example, in giving stable restoration after storage of nozzle.

The total amount of the water-soluble polymer, the water-soluble oligomer, the resin emulsion and the inorganic oxide added to the processing solution is preferably about 0.1 to about 50 weight % as solid content. A solid content of about 0.1 weight % or more is effective in improving the fixing efficiency of the printed matter at a desired density. A solid content of about 50 weight % or less is effective in keeping the ejection stability during ejection by the ink-ejecting unit, the coating properties during coating in a coating system, and the image drying efficiency favorable.

The surface tension of the processing solution according to the exemplary embodiment of the invention is preferably in the range of about 20 to about 40 mN/m. A processing solution having a surface tension in the range above has a shorter image-drying time and also a favorable image quality-improving effect. The surface tension was determined by using Wilhelmy method under an environment at 23° C. and 55% RH.

The penetration speed of the processing solution and the ink of the exemplary embodiment of the invention described below in the paper is preferably about 5 seconds or less, more preferably about 3 seconds or less. The penetration speed may vary according to the paper used. For example, it may be possible to control the penetration speed in common plain paper to about 5 seconds or less, easily by adjusting the kinds and amounts of the surfactant used in the processing solution and the ink and the penetrative solvent.

When the processing solution is the aggregating processing solution, the penetration speed of the processing solution in paper is preferably higher than that of the ink. When the penetration speed of the processing solution is higher than that of the ink, it is may be to perform drying more favorably and prevent surface irregularity of the image effectively. The penetration speed can be determined by printing a 100%-coverage pattern, pressing another P paper on the printed pattern (manufactured by Fuji Xerox Office Supply Co., Ltd.) under a load of 1.9×10⁴ N/m² after a predetermined period, and measuring the period until no ink is transferred onto the P paper pressed.

—Ink—

Hereinafter, the ink used in the exemplary embodiment of the invention will be described.

The ink used in the image recording device in the first aspect of the invention and the image recording method in the first aspect of the invention described below may contain a colorant. If necessary, additionally other components such as water, water-soluble organic solvent, and surfactant may be contained. In the first aspect of the invention, a polybasic acid may be added to the processing solution, and further “a polybasic acid having two or more groups interactive with the paper components in the molecule” may be added to the ink. In this way, it may be possible to improve curling resistance and stiffness distinctively. The amount of the polybasic acid in ink, when added, is preferably about 0.2 to about 20 weight %, more preferably about 1 to about 10 weight %, with respect to the total weight of the ink.

The ink used in the image recording device in the second aspect of the invention and the image recording method in the second aspect of the invention described below contains a colorant and a polybasic acid having two or more groups interactive with the paper components in the molecule. The “group interactive with the paper components” refers to a group interactive or chemically reactive with the paper components. Specifically, when the paper component has hydroxyl groups, the group is a group interactive by hydrogen-bonding force or chemically reactive with the hydroxyl group. Details of the polybasic acid contained in the ink used in the second aspect (group interactive with the paper components in the polybasic acid and specific examples thereof) are the same as those described above. The mechanism for improvement in the curling resistance and the stiffness of paper is yet to be understood, but seems to operate as follows:

In a recording medium (paper) such as pulp paper, the hydroxyl groups contained in the cellulose structure, the principal component in paper, interact with each other by hydrogen-bonding force. When printing is performed by using an aqueous ink, water penetrates into the hydrogen bonds among cellulose molecules in paper, causing phase change of the hydrogen-bonding region and consequently deformation and deterioration in stiffness of the paper. However, it seems possible to crosslink the fibers to each other effectively and to prevent the deformation and deterioration in stiffness of the paper by penetration of water, by supplying an ink containing a polybasic acid having two or more groups interactive with the paper components in the molecule to the paper and by supplying energy from outside. In particular, when an ink containing a polybasic acid having two or more carboxyl groups in the molecule is used, the carboxyl groups and the hydroxyl groups in paper react with each other in esterification reaction. Accordingly, it seems possible to improve the stiffness and resistance to curling of the paper.

The amount of the polybasic acid added to the ink used in the image recording device in the second aspect of the invention and the image recording method in the second aspect of the invention described below is preferably about 0.2 to about 20 weight %, more preferably about 1 to about 10 weight %, with respect to the total weight of the ink. An addition amount of about 0.2 weight % or more is effective in giving a favorable curling resistance. An addition amount of about 20 weight % or less is effective in preventing degradation of the ink over time and unstable injection.

Hereinafter, the composition of the ink used in the exemplary embodiment of the invention will be described.

The colorant used in the ink may be a dye or a pigment. The colorant is preferably one or more pigments. It is because pigments cause aggregation more easily than dyes when mixed with the processing solution. There is recently an increased requirement in the quality of black image used in printing characters in office, and thus, carbon black, a black pigment superior in the water resistance and the light-fastness of image, is favorably used in the black ink. Among pigments, pigments dispersed in polymer dispersant, self-dispersible pigments, and resin-coated pigments are preferable.

Both organic and inorganic pigments may be used as the pigment of the exemplary embodiment of the invention. Examples of black pigments include carbon black pigments such as furnace black, lamp black, acetylene black, and channel black. In addition to black pigments and color pigments in three primary colors of cyan, magenta, and yellow, pigments in a particular color such as red, green, blue, brown, or white and pigments having metallic glossiness in the color of gold or silver or the like, colorless or light-colored extender pigments, plastic pigments, and the like may also be used. In addition, particles that a dye or pigment is firmly fixed on the surface of a silica, an alumina, a polymer bead, or the like as the core, insoluble dye lakes, colored emulsions, colored latexes, and the like are also usable as the pigment. A pigment newly prepared for the exemplary embodiment of the invention may be also used.

Examples of the pigments include Raven 7000, Raven 5750, Raven 5250, Raven 5000 ULTRAII, Raven 3500, Raven 2500 ULTRA, Raven 2000, Raven 1500, Raven 1255, Raven 1250, Raven 1200, Raven 1190 ULTRAII, Raven 1170, Raven 1080 ULTRA, Raven 1060 ULTRA, Raven 790 ULTRA, Raven 780 ULTRA, and Raven 760 ULTRA (manufactured by Columbian Chemicals Company); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (manufactured by Cabot Corporation); Color Black FW1, Color Black FW2, Color Black FW2V, Color Black 18, Color Black FW200, Color Black S150, Color Black S160, Color Black S170, Printex 35, Printex U, Printex V, Printex 140U, Printex 140V, Special Black 6, Special Black 5, Special Black 4A, and Special Black 4 (manufactured by Degussa); No. 25, No. 33, No. 40, No. 47, No. 52, No. 900, No. 2300, MCF-88, MA600, MA7, MA8, and MA100 (manufactured by Mitsubishi Chemical Co., Ltd.); and the like. However, the exemplary embodiment of the invention is not limited to these examples.

### Alternatively, magnetic material particles such as magnetite or ferrite, titanium black or the like may be used as the black pigment.

The colorant is also preferably a pigment self-dispersible in water. The self-dispersible pigments are pigments self-dispersible in water that have numerous water-solubilizing groups on the pigment surface and are dispersed in water reliably without presence of a polymer dispersant. Specifically, the pigments self-dispersible in water are prepared, for example, by surface modifying treatment such as acid-base treatment, coupling agent treatment, polymer graft treatment, plasma treatment, or oxidative/reductive treatment, of common so-called pigments.

In addition to the surface-modified pigments described above, commercially available self-dispersible pigments including Cab-o-jet-200, Cab-o-jet-250, Cab-o-jet-260, Cab-o-jet-270, Cab-o-jet-300, IJX-444, and IJX-55 manufactured by Cabot Corporation; Microjet Black CW-1 and CW-2 manufactured by Orient Chemical Industries, Ltd.; the self-dispersible pigments available from Nippon Shokubai Co., Ltd.; and the like may be used as the pigments self-dispersible in water.

Examples of the cyan pigments include C.I. Pigment Blue-1, -2, -3, -15, -15:1, -15:2, -15:3, -15:4, -16, -22, and -60 and the like. However, the exemplary embodiment of the invention is not limited to these examples.

Examples of the magenta pigments include C.I. Pigment Red-5, -7, -12, -48, -48:1, -57, -112, -122, -123, -146, -168, -184, and -202 and the like. However, the exemplary embodiment of the invention is not limited to these examples.

Examples of the yellow pigments include C.I. Pigment Yellow-1, -2, -3, -12, -13, -14, -16, -17, -73, -74, -75, -83, -93, -95, -97, -98, -114, -128, -129, -138, -151, -154, and -180 and the like. However, the exemplary embodiment of the invention is not limited to these examples.

In addition, so-called encapsulated dyes or pigments containing colorants encapsulated in various resins may be used as the colorants in respective colors.

On the other hand, a water-soluble or disperse dye may be used as the dye used in the exemplary embodiment of the invention. Examples of the dyes used include direct dyes, acid dyes, edible dyes, basic dyes, reactive dyes, disperse dyes, construction dyes, soluble construction dyes, reactive disperse dyes, oil-based dyes, and the like.

Specific examples of the water-soluble dyes include C.I. Direct Black-2, -4, -9, -11, -17, -19, -22, -32, -80, -151, -154, -168, -171, -194, and -195; C.I. Direct Blue-1, -2, -6, -8, -22, -34, -70, -71, -76, -78, -86, -112, -142, -165, -199, -200, -201, -202, -203, -207, -218, -236, -287, and -307; C.I. Direct Red-1, -2, -4, -8, -9, -11, -13, -15, -20, -28, -31, -33, -37, -39, -51, -59, -62, -63, -73, -75, -80, -81, -83, -87, -90, -94, -95, -99, -101, -110, -189, and -227; C.I. Direct Yellow-1, -2, -4, -8, -11, -12, -26, -27, -28, -33, -34, -41, -44, -48, -58, -86, -87, -88, -132, -135, -142, 144, and -173; C.I. Food Black-1 and -2; C.I. Acid Black-1, -2, -7, -16, -24, -26, -28, -31, -48, -52, -63, -107, -112, -118, -119, -121, -156, -172, -194, and -208; C.I. Acid Blue-1, -7, -9, -15, -22, -23, -27, -29, -40, -43, -55, -59, -62, -78, -80, -81, -83, -90, -102, -104, -111, -185, -249, and -254; C.I. Acid Red-1, -4, -8, -13, -14, -15, -18, -21, -26, -35, -37, -52, -110, -144, -180, -249, -257, and -289; C.I. Acid Yellow-1, -3, -4, -7, -11, -12, -13, -14, -18, -19, -23, -25, -34, -38, -41, -42, -44, -53, -55, -61, -71, -76, -78, -79, and -122; and the like.

Specific examples of the disperse dyes include C.I. Disperse Yellow-3, -5, -7, -8, -42, -54, -64, -79, -82, -83, -93, -100, -119, -122, -126, -160, -184:1, -186, -198, -204, and -224; C.I. Disperse Orange-13, -29, -31:1, -33, -49, -54, -66, -73, -119, and -163; C.I. Disperse Red-1, -4, -11, -17, -19, -54, -60, -72, -73, -86, -92, -93, -126, -127, -135, -145, -154, -164, -167:1, -177, -181, -207, -239, -240, -258, -278, -283, -311, -343, -348, -356, and -362; C.I. Disperse Violet-33; C.I. Disperse Blue-14, -26, -56, -60, -73, -87, -128, -143, -154, -165, -165:1, -176, -183, -185, -201, -214, -224, -257, -287, -354, -365, and -368; C.I. Disperse Green-6:1 and -9; and the like.

The colorant used in the exemplary embodiment of the invention is preferably a colorant containing a sulfo group and/or the salt thereof in the molecule, from the viewpoint of ink reliability. Use of a cationic colorant is also preferable, similarly from the viewpoint of ink reliability.

The colorant used in the exemplary embodiment of the invention is preferably contained in an amount in the range of about 1 to about 15 weight %, more preferably in the range of about 2 to about 10 weight %, with respect to the total weight of the ink. An ink colorant amount of about 1 weight % or more is effective in giving a sufficient high optical density, while a colorant amount of about 15 weight % or less in giving favorable liquid injection stability.

In the exemplary embodiment of the invention, a water-soluble organic solvent is preferably used in the ink as the material for giving moisture and adjusting the liquid viscosity.

Examples of the water-soluble organic solvents include polyvalent alcohols such as ethylene glycol, diethylene glycol, propylene glycol, polypropylene glycol, butylene glycol, triethylene glycol, 1,5-pentanediol, 1,2,6-hexanetriol, and glycerin; nitrogen-containing solvents such as pyrrolidone, N-methyl-2-pyrrolidone, cyclohexylpyrrolidone, and triethanolamine; alcohols such as ethanol, isopropyl alcohol, butyl alcohol, and benzyl alcohol; sulfur-containing solvents such as thiodiethanol, thiodiglycerol, sulfolane, and dimethyl sulfoxide; propylene carbonate; ethylene carbonate, and the like. However, the exemplary embodiment of the invention is not limited to these examples.

The water-soluble organic solvents used in the exemplary embodiment of the invention may be used by itself or in a combination of two or more thereof. The content of the water-soluble organic solvent is preferably in the range of about 1 to about 60 weight %, more preferably in the range of about 5 to about 40 weight %, with respect to the total weight of the ink.

Normally, water is used in the ink. The water may be ion-exchange water, distilled water, pure water, ultrapure water, or the like.

The content of water in the ink is preferably in the range of about 20 to about 80 weight %, particularly preferably in the range of about 30 to about 60 weight %. When the content is about 20 weight % or more, it may be possible to eject the ink favorably with favorable ejection stability. Also when the content is about 80 weight % or less, it may be possible to obtain favorable storage characteristics over a long period.

The liquid viscosity of the ink is preferably in the range of about 1 to about 20 mPa·s. When the viscosity is about 1 mPa·s or more, it may be possible to form a high-quality image on the recording medium (paper) and have favorable ejection stability because of increase in viscosity. On the other hand, when the viscosity is about 20 mPa·s or less, it may be possible to obtain favorable ejection stability and prevent generation of incomplete or low-density image effectively.

The ink may contain a water-soluble resin for improvement in image density, ink-bleeding resistance, ink-bleeding resistance between colors, and image uniformity, and for prevention of clogging and adjustment of ejecting responsiveness, ejection stability and storage characteristics. In particular, addition of a water-soluble resin to the ink is effective in amplifying improvement in image quality. Seemingly, it seems it is because addition of a water-soluble resin helps networking among the colorant molecules and facilitates the colorant to have a three dimensional structure in the ink, and in particular, it seems that when the aggregating processing solution described above is used (when the processing solution described above is an aggregating processing solution in the first aspect of the invention), it facilitates and amplifies thickening in case of mixing the ink with the processing solution. Addition of the water-soluble resin is effective in making the colorant retain the network structure on the paper even after image formation and thus in giving an image superior in fixing efficiency and abrasion resistance.

The water-soluble resin includes a compound having both hydrophilic structural regions and hydrophobic structural regions. Specific examples thereof include condensation polymers, addition polymers and the like. Examples of the condensation polymers include polyester-based polymers. Examples of the addition polymers include addition polymers of monomer having an α, β-ethylenic unsaturated group. Examples of the addition polymers include copolymers suitably combined a monomer having an α,β-ethylenic unsaturated group including a hydrophilic group and a monomer having an α,β-ethylenic unsaturated group including a hydrophobic group. In addition, homopolymers consisting of a monomer having an α,β-ethylenic unsaturated group including a hydrophilic group can also be used.

Examples of the monomers having an α, β-ethylenic unsaturated group including hydrophilic group include monomers having a carboxyl group, a sulfonic acid group, a hydroxyl group, or a phosphoric acid group or the like, such as acrylic acid, methacrylic acid, crotonic acid, itaconic acid, monoitaconate ester, maleic acid, monomaleate ester, fumaric acid, monofumarate ester, vinylsulfonic acid, styrenesulfonic acid, sulfonated vinylnaphthalene, vinylalcohol, acrylamide, methacryloxyethyl phosphate, bismethacryloxyethyl phosphate, methacryloxyethylphenyl acid phosphate, ethylene glycol dimethacrylate, and diethylene glycol dimethacrylate.

On the other hand, examples of the monomers having an α, β-ethylenic unsaturated group including a hydrophobic group include styrene derivatives such as styrene, α-methylstyrene, and vinyltoluene; vinylcyclohexane, vinylnaphthalene, vinylnaphthalene derivatives, alkyl acrylate esters, phenyl acrylate esters, alkyl methacrylate esters, phenyl methacrylate ester, cycloalkyl methacrylate esters, alkyl crotonate esters, dialkyl itaconate esters, dialkyl maleate esters, and the like.

Copolymers obtained by copolymerization of a monomer having both hydrophilic and hydrophobic groups may have any structure of random, block, graft, or other structure.

Examples of the preferable copolymers include styrene-styrenesulfonic acid copolymers, styrene-maleic acid copolymers, styrene-methacrylic acid copolymers, styrene-acrylic acid copolymers, vinylnaphthalene-maleic acid copolymers, vinylnaphthalene-methacrylic acid copolymers, vinylnaphthalene-acrylic acid copolymers, alkyl acrylate ester-acrylic acid copolymers, alkyl methacrylate ester-methacrylic acid copolymers, styrene-alkyl methacrylate ester-methacrylic acid copolymers, styrene-alkyl acrylate ester-acrylic acid copolymers, styrene-phenyl methacrylate ester-methacrylic acid copolymers, styrene-cyclohexyl methacrylate ester-methacrylic acid copolymers, and the like.

The copolymer may be additionally copolymerized suitably with a monomer having a polyoxyethylene group or a hydroxyl group. For improvement in compatibility with a pigment having acidic functional groups on the surface and in dispersion stability of the mixture, a monomer having a cationic functional group, such as N,N-dimethylaminoethyl methacrylate, N,N-dimethylaminoethyl acrylate, N,N-dimethylaminomethacrylamide, N,N-dimethylaminoacrylamide, N-vinylpyrrole, N-vinylpyridine, N-vinylpyrrolidone, or N-vinylimidazole, may be copolymerized suitably.

In addition, polystyrenesulfonic acid, polyacrylic acid, polymethacrylic acid, polyvinylsulfuric acid, polyalginic acid, polyoxyethylene-polyoxypropylene-polyoxyethylene block copolymers, naphthalenesulfonic acid formalin condensates, polyvinylpyrrolidone, polyethyleneimine, polyamines, polyamides, polyvinylimidazoline, aminoalkyl acrylate-acrylamide copolymers, chitosan, polyoxyethylene alkylethers, polyoxyethylene alkylphenylethers, polyoxyethylene fatty acid amides, polyvinyl alcohol, polyacrylamide, cellulose derivatives such as carboxymethylcellulose and carboxyethylcellulose, polysaccharides and the derivatives thereof, and others are also used favorably.

The hydrophilic group of the water-soluble resin is preferably, but not limited to, carboxylic acid or a salt thereof. It is probably because the colorant aggregates favorably on paper when the hydrophilic group is carboxylic acid.

Among these water-soluble resins, copolymers having an acidic group as a hydrophilic group are used preferably as the salt with a basic compound, for improvement in water-solubility.

Examples of the compounds forming a salt with the polymer include alkali metals such as sodium, potassium, and lithium; aliphatic amines such as monomethylamine, dimethylamine, and triethylamine; alcohol amines such as monomethanolamine, monoethanolamine, diethanolamine, triethanolamine, and diisopropanolamine; ammonia; and the like.

Preferably used is a basic compound of an alkali metal such as sodium, potassium, or lithium. It is probably because the alkali metal salt is a strong electrolyte and thus facilitates dissociation of the hydrophilic group.

The neutralization amount of the water-soluble resin is preferably about 60% or more, more preferably about 80% or more, with respect to the acid value of the copolymer.

These water-soluble resins may be used by itself or in a combination of two or more thereof.

In addition, the ink used in the exemplary embodiment of the invention may contain various additives such as polyethyleneimine, polyamines, polyvinylpyrrolidone, polyethylene glycol, cellulose derivatives (such as methylcellulose, ethylcellulose, and carboxyethylcellulose), glucose, fructose, mannitol, D-sorbit, polysaccharides (such as dextran, xanthan gum, curdlan, cycloamylose, and maltitol) and the derivatives thereof, other polymer emulsions, cyclodextrin, macrocyclic amines, dendrimers, crown ethers, urea and the derivatives thereof, and acetamide.

Other additive such as antioxidant, fungicide, conductive agent, ultraviolet absorber, and chelating agent may also be added suitably. Examples of the chelating agents include ethylenediamine tetraacetic acid (EDTA), imino diacetic acid (IDA), ethylenediamine-di(o-hydroxyphenylacetic acid) (EDDHA), nitrilotriacetic acid (NTA), dihydroxyethyl glycine (DHEG), trans-1,2-cyclohexanediaminetetraacetic acid (CyDTA), diethylenetriamine-N,N,N′,N′,N′-pentaacetic acid (DTPA), glycol ether diamine-N,N,N′,N′-tetraacetic acid (GEDTA) and the like.

Other electrolytes and cationic substances may be added additionally in the range that does not cause secondary disorder. Examples of the electrolytes include alkali metal ions such as lithium ion, sodium ion, and potassium ion; and other metal ions such as aluminum ion, barium ion, calcium ion, copper ion, iron ion, magnesium ion, manganese ion, nickel ion, tin ion, titanium ion, and zinc ion.

The ink used in the exemplary embodiment of the invention may contain a surfactant and the like as its penetrant.

The surfactant may be a nonionic, anionic, cationic, or amphoteric surfactant. Examples of the nonionic surfactants include polyoxyethylene nonylphenylether, polyoxyethylene octylphenylether, polyoxyethylene dodecylphenylether, polyoxyethylene alkylethers, polyoxyethylene fatty acid esters, sorbitan fatty acid esters, polyoxyethylene sorbitan fatty acid esters, fatty acid alkylol amides, acetylene alcohol ethyleneoxide adducts, polyethylene glycol polypropylene glycol block copolymers, polyoxyethylene ethers of glycerin ester, polyoxyethylene ethers of sorbitol ester, and the like.

Examples of the anionic surfactants include alkylbenzenesulfonate salts, alkylphenylsulfonate salts, alkylnaphthalenesulfonate salts, higher fatty acid salts, higher fatty ester sulfate ester salts and sulfonate salts, and higher alkyl sulfoscuccinate salts, and the like.

Examples of the cationic surfactants include tetraalkylammonium salts, alkylamine salts, benzalkonium salts, alkylpyridium salts, imidazolium salts, and the like, and specific examples thereof include dihydroxyethylstearylamine, 2-heptadecenyl-hydroxyethylimidazoline, lauryldimethylbenzylammonium chloride, cetylpyridinium chloride, stearamidomethylpyridium chloride and the like.

Examples of the amphoteric surfactants include betaine, sulfobetaine, sulfate betaine, imidazoline, and the like. Other examples thereof include silicone surfactants such as polysiloxane polyoxyethylene adducts, fluorine-based surfactants such as oxyethylene perfluoroalkylether, and biosurfactants such as spiculisporic acid, rhamnolipid, and lysolecithin.

These surfactants may be used by itself or in a combination of two or more thereof. The amount of the surfactant contained in the ink is preferably in the range of about 0.001 to about 10 weight % with respect to the total weight of the ink, from the viewpoints of surface tension and wetting characteristic.

The ink used in the exemplary embodiment of the invention preferably has a surface tension in the range of about 20 to about 60 mN/m.

The surface tension is determined in a Wilhelmy surface tension balance (manufactured by Kyowa Interface Science Co., Ltd.) under an environment of 23° C. and 55% RH.

—Recording Medium—

Hereinafter, the recording medium used in the exemplary embodiment of the invention will be described.

The recording medium used in the exemplary embodiment of the invention preferably contains a component having a hydroxyl group, and specific examples thereof include the recording media (papers) below.

The paper according to the exemplary embodiment of the invention is preferably paper using, for example, cellulose pulp as its raw material, and may be any one of the following base papers, or a plain paper having a pigment, a binder and others finished on the base paper surface. The base paper contains cellulose pulp, and any known pulps may be used as the cellulose pulp. Specific examples thereof include chemical pulps (such as broadleaf bleached Kraft pulp, broadleaf unbleached Kraft pulp, needle-leaf bleached Kraft pulp, needle-leaf unbleached Kraft pulp, broadleaf bleached sulfite pulp, broadleaf unbleached sulfite pulp, needle-leaf bleached sulfite pulp, needle-leaf unbleached sulfite pulp, and pulps prepared by chemical processing of fibrous materials such as wood, cotton, hemp, and soft leather) and the like.

In addition, ground wood pulps mechanically pulped from woods and chips, chemimechanical pulps mechanically pulped from woods and chips previously impregnated with chemicals, thermomechanical pulps pulped in refiner after chips are steamed until they become slightly softer, and the like may also be used. These pulps may be prepared only from a virgin pulp or combinedly with a waste paper pulp as needed.

In particular, when a virgin pulp is used, it is preferably an elementally chlorine free (EFC) pulp bleached not by chlorine gas but by chlorine dioxide, or a total chlorine free (TCF) pulp bleached mainly by ozone/hydrogen peroxide or the like without use of any chlorine compounds.

The basis weight of the paper according to the exemplary embodiment of the invention is not particularly limited, but preferably in the range of about 60 to about 128 g/m², more preferably about 60 to about 100 g/m², and still more preferably about 60 to about 90 g/m². When a basis weight is about 128 g/m² or less, it may be possible to make the stiffness of paper favorable in strength and thus to obtain favorable printer paper travelling efficiency. Also when a basis weight is about 60 g/m² or more, it may be possible to reduce generation of curling and waviness, and thus, such a basis weight is preferable from the viewpoint of offsetting.

It is also preferable to control the fiber orientation ratio in the range of 1.00 to 1.55, or about 1.00 to about 1.55, more preferably in the range of 1.00 to 1.40, or about 1.00 to about 1.40, and still more preferably in the range of 1.05 to 1.35, or about 1.05 to about 1.35 during sheeting. Proper control of the fiber orientation ratio in this manner allows reduction in the frequency of curling of the paper (recording medium) after printing by ink-jet process. The fiber orientation ratio is a value determined by ultrasonic transmission velocity method, i.e., a value calculated by dividing the ultrasonic transmission velocity in the MD direction (the traveling direction of the paper in a sheeting machine) of the recording paper by that in the CD direction (the direction orthogonal to the MD direction), as defined in the following formula:

[Fiber orientation ratio of base paper (T/Y ratio) as determined by ultrasonic transmission velocity method]=(Ultrasonic transmission velocity in MD direction)÷(Ultrasonic Transmission Velocity in CD Direction)

The fiber orientation ratio by the ultrasonic transmission velocity method is determined by using Sonic Sheet Tester (manufactured by Nomura Shoji Co., Ltd.).

The paper according to the exemplary embodiment of the invention preferably contains a cationic polymer and/or a polyvalent metal salt on the surface. If the surface of paper contains a cationic polymer and/or a polyvalent metal salt and the ink contains an anionic polymer, crosslinking between these ingredients allows extremely fast coagulation of colorants, provides an image excellent in printing quality, and suppresses penetration of the ink solvent into paper. Thus, it may be possible to prevent generation of the curl and cockle immediately after printing and after storing and drying.

Examples of the polyvalent metal salts include chloride, sulfate salt, nitrate, formate, acetate, and other salts of potassium, barium, calcium, magnesium, zinc, tin, manganese, aluminum, and other polyvalent metals. Specific examples thereof include barium chloride, calcium chloride, calcium acetate, calcium nitrate, calcium formate, magnesium chloride, manganese sulfate, magnesium nitrate, magnesium acetate, magnesium formate, zinc chloride, zinc sulfate, zinc nitrate, zinc formate, tin chloride, tin nitrate, manganese chloride, manganese sulfate, manganese nitrate, manganese formate, aluminum sulfate, aluminum nitrate, aluminum chloride, aluminum acetate, and the like. These salts may be used by itself or in a combination of two or more thereof. Among these polyvalent metal salts, metal salts having higher ionic valency and are more soluble in water are preferable. Further, because paper turns yellow after application in case of using of a strong acid as the counter ion of the polyvalent metal salt, the metal salts are preferably calcium chloride, calcium formate, magnesium chloride, and magnesium formate. Examples of the cationic polymers include, but are not limited to, cationic cellulose, cationic starch, and the like.

The cationic polymers and the polyvalent metal salts listed above can be applied on the surface of recording papers, by blending them in a surface sizing solution when the surface is finished with the surface-sizing solution, or by preparing a separate coating solution containing the same. In the latter case, the coating solution obtained by dissolving them in water may be directly applied onto the paper, but is usually blended with a binder before use.

The amount of each of the cationic polymer and the polyvalent metal salt contained in recording paper surface is preferably in the range of about 0.1 to about 2.0 g/m² and more preferably in the range of about 0.5 to about 1.0 g/m². It may be possible to advance the reaction between the pigment and the anionic polymer in ink further and give a high-quality image, and prevent curling and waviness immediately after printing and curling and waviness after storage and drying more effectively at a content of about 0.1 g/m² or more. It may be possible to obtain favorable penetration of the ink and favorable ink drying efficiency, particularly during high-speed printing at a content of about 2.0 g/m² or less.

—Processes in Image Recording Method—

Hereinafter, processes in the image recording method of the exemplary embodiment of the invention will be described.

The image recording method in the first aspect of the invention characteristically includes at least the following (a), (b), and (c):

(a) a processing solution containing a polybasic acid having two or more groups interactive with the paper components in the molecule is supplied onto one side or both sides of the recording medium (paper) [hereinafter, this (a) is referred to as “processing solution-supplying process a”].

(b) an energy is supplied to the recording medium (paper) from an energy-supplying unit [hereinafter, this (b) is referred to as “energy-supplying process b”].

(c) the ink is ejected from an ink-ejecting unit onto the printing surface of the recording medium (paper) [hereinafter, this (c) is referred to as “ink-ejecting process c”].

The energy-supplying process b is preferably carried out after the processing solution-supplying process a. In that order, it may be possible to allow penetration of the polybasic acid according to the exemplary embodiment of the invention into paper before interaction with the paper and thus to improve curling resistance and stiffness more distinctively.

In such a case, the ink-ejecting process c is preferably carried out after the energy-supplying process b. In the order, it may be possible to effectively prevent penetration of the water in ink between hydrogen bonds and to improve curling resistance and stiffness more distinctively.

Alternatively, the image recording method in the second aspect of the invention characteristically includes at least the following (d), and (e):

(d) an ink containing a colorant and a polybasic acid having two or more groups interactive with the paper components in the molecule is ejected from an ink-ejecting unit onto the printing face of the recording medium (paper) [hereinafter, this (d) is referred to as “ink-ejecting process d”].

(e) an energy is supplied to the recording medium (paper) from an energy-supplying unit [hereinafter, this (e) is referred to as “energy-supplying process e”].

The energy-supplying process e is preferably carried out after the ink-ejecting process d. In the order, it may be possible to allow penetration of the polybasic acid according to the exemplary embodiment of the invention into paper before interaction with the paper and thus to improve curling resistance and stiffness more distinctively.

In addition, the energy-supplying process e is preferably carried out before and after the ink-ejecting process d. By supplying energy before and after the process, it may be possible to improve curling resistance and stiffness and also to obtain more favorable image quality (image density).

—Processing Solution-Supplying Process a—

The method of supplying a processing solution on one side or both sides of paper is not particularly limited in the exemplary embodiment of the invention, and any known method may be used suitably. Examples of the favorable methods include ejection with an ink-ejecting unit (inkjet printing), roller coating, blade coating, screen coating, spray coating, and the like, and among them, more favorable from the viewpoints of the stability and reliability of coating amount are ejection with an ink-ejecting unit (inkjet printing), roller coating, and blade coating.

When the processing solution is supplied by ejection with an ink-ejecting unit, specifically the ink-ejecting unit has a configuration similar to the specific example of the configuration (unit of ejecting a single ink in a recording head ejecting multiple inks) shown in the ink-ejecting process described below.

In the processing solution-supplying process a, the processing solution is supplied at least onto one side or both sides as described above, but preferably on both sides. By supplying it on both sides it may be possible to improve curling resistance and stiffness more distinctively.

When the processing solution is supplied only onto one side, the feed rate of the processing solution is preferably adjusted so that the feed rate of the polybasic acid according to the exemplary embodiment of the invention to the paper becomes about 0.03 to about 20 g/m², more preferably about 0.1 to about 10 g/m².

Alternatively, when it is supplied onto both sides, the total feed rated of the polybasic acid on the recording paper is preferably controlled to be about 0.03 to about 20 g/m², more preferably to be about 0.15 to about 10 g/m².

—Energy-Supplying Processs b and e—

In the exemplary embodiment of the invention, it may be possible to improve curling resistance and stiffness favorably by supplying the processing solution and also by supplying energy. In the exemplary embodiment of the invention, it may be possible to control the degree of crosslinking easily and have desired effects easily, by adjusting the amount of energy supplied.

Examples of the energy-supplying unit favorably used in the exemplary embodiment of the invention include, but are not limited to, heating unit such as heater, electromagnetic wave-irradiating unit, and the like. The heater may be a far-infrared heater, a heater generating heat by application of current to the resistor, or the like, and the electromagnetic wave irradiation is, for example, irradiation of microwave or high-frequency wave. Among them, an electromagnetic wave-irradiating unit is more preferable, and a microwave or high-frequency irradiation unit is particularly preferable, from the viewpoints of energy efficiency and energy-transmitting speed. The energy-supplying unit may or may not come in contact with the recording medium during energy supply.

Hereinafter, an aspect of the heater will be described with reference to the drawings.

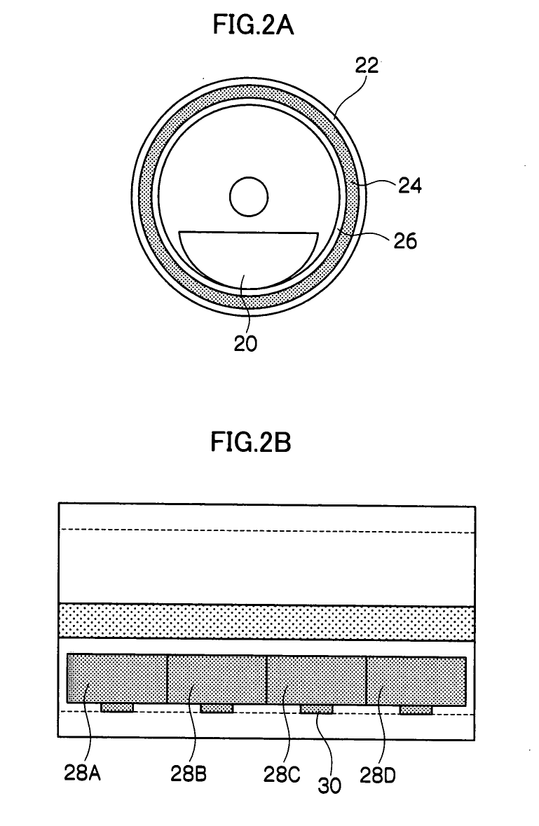

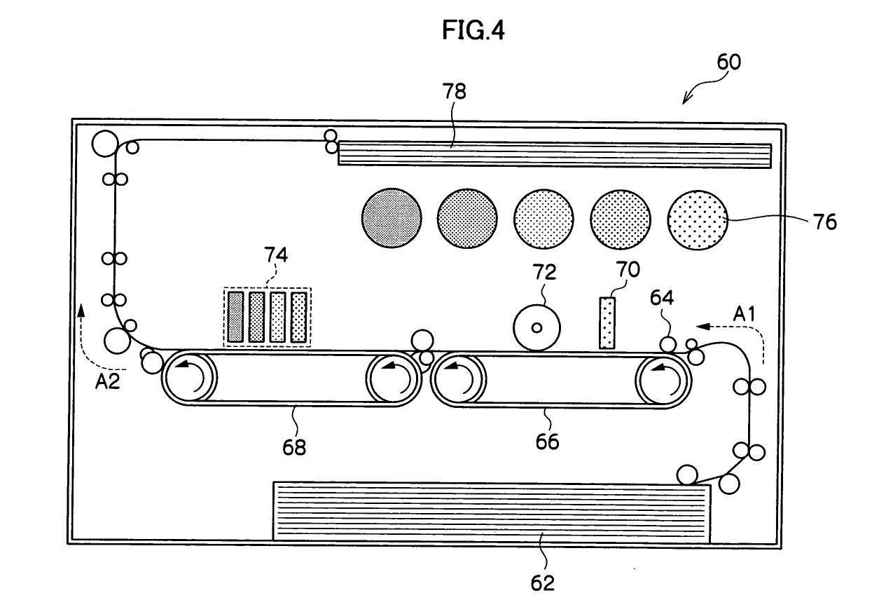

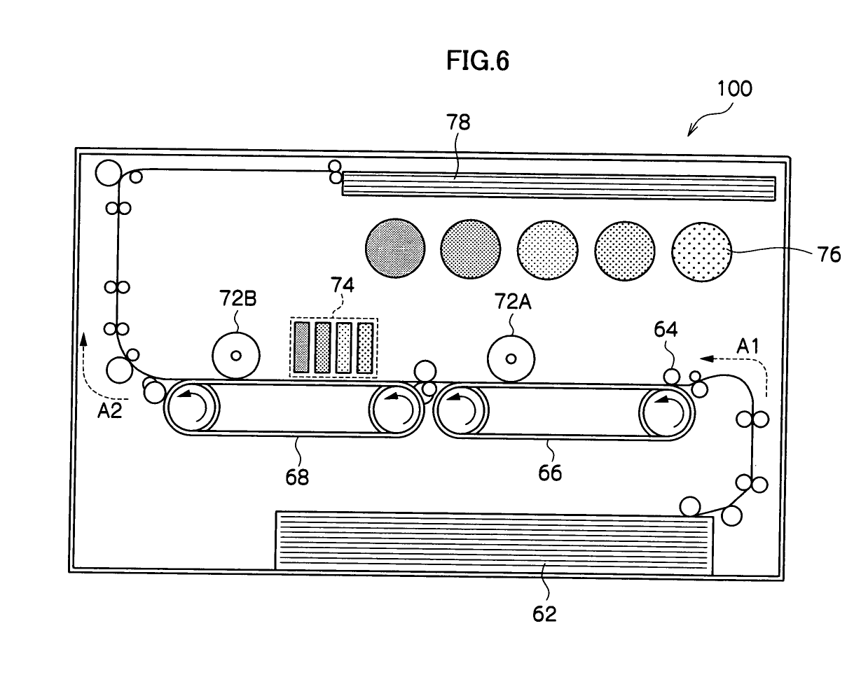

FIG. 2A is a schematic sectional view illustrating a heating roller as a heating unit (electromagnetic induction heating device). FIG. 2B is a schematic view illustrating the configuration of a coil 20 shown in FIG. 2A in detail. The heating roller shown in FIG. 2A has an electrically conductive layer 24 and a surface layer 22 on the surface of an elastic layer 26, and the coil 20 is put inside the elastic layer 26. As shown in FIG. 2B, the coil 20 has a temperature sensor 30, and Alternating current is applied to divided coils 28A to 28D, according to the temperature detected by the temperature sensor 30. The heating roller is a heating unit of heating the paper, while pressed toward an endless-belt conveyer 66, as indicated by a heating roll 72 in FIG. 4 and heating rolls 72A and 72B in FIG. 6.

The surface layer 22 is preferably a sheet or a coat layer having a thickness of 0.1 to 30 μm superior in release characteristics. Examples of the materials for the layer include tetrafluoroethylene-perfluoroalkyl vinylether copolymers, polytetrafluoroethylene-silicone copolymers and the like. The electrically conductive layer 24 is preferably, for example, an iron or cobalt layer or a plated nickel, copper, or chromium metal layer having a thickness of 1 to 50 μm. The elastic layer 26 is preferably made of a material superior in heat resistance and heat conductivity such as silicone rubber, fluorine rubber, or fluorosilicone rubber, and the thickness thereof is preferably 10 to 500 μm.

The heating roller is preferably installed in the image recording device according to the exemplary embodiment of the invention at a contact width (nip width) of 1 to 10 mm under a pressure of 0.1 to 6 kg/cm².

For more favorable advancement of the crosslinking reaction and more favorable improvement in curling resistance and stiffness, the heating contact time of the heating roller is preferably 5 to 50 ms, and the frequency of the alternating current applied to the electromagnetic induction coil is preferably 10 to 100 kHz.

An aspect of the method that energy is applied by microwave will be described with reference to the drawings.

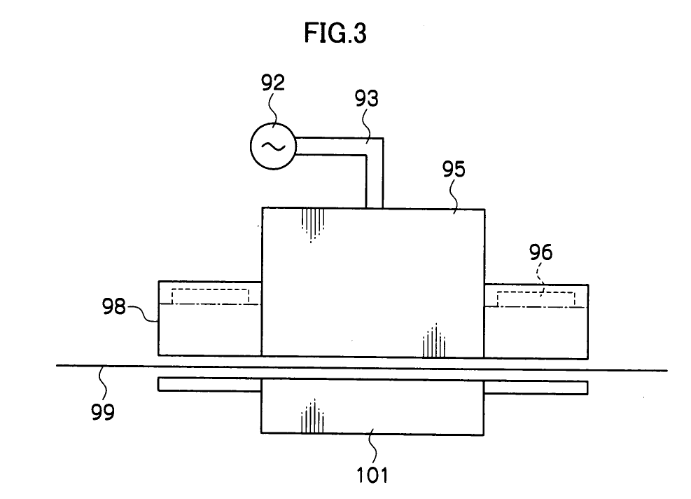

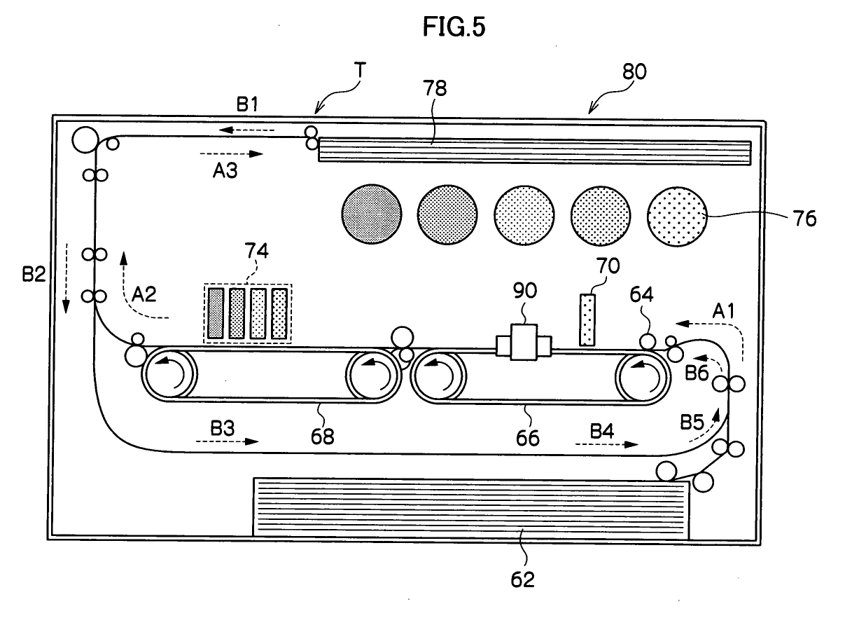

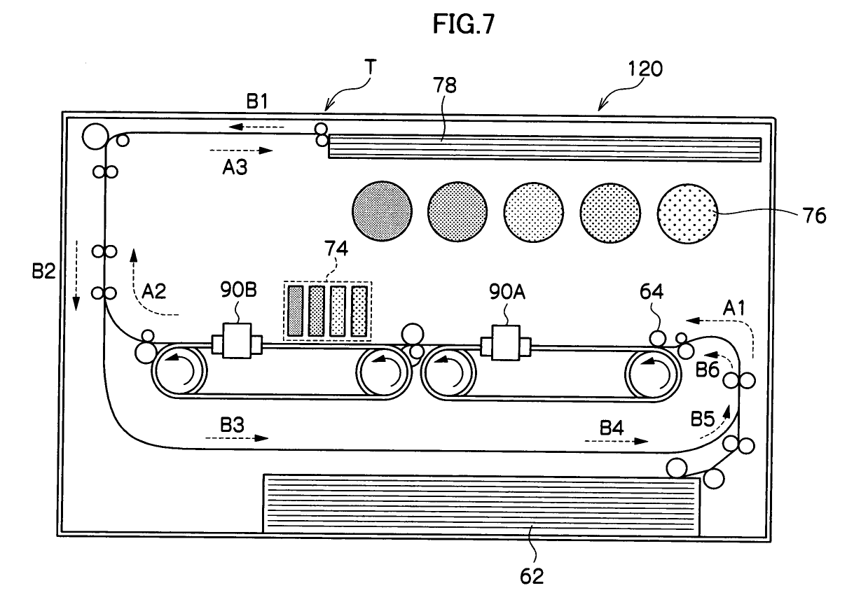

FIG. 3 is a schematic sectional view illustrating a microwave-irradiating device as the energy-supplying unit. The microwave-irradiating device shown in FIG. 3 has a microwave irradiator 92 irradiating microwave, a paper-drying chamber 95, a waveguide pipe 93 guiding the irradiated microwave into the paper-drying chamber 95, a reflector 98 reflecting the microwave, a radiowave absorbent 96 absorbing the microwave, and a supporting stand 101, and paper is supplied by a conveyor belt 99 into the region held between the paper-drying chamber 95 and the supporting stand 101. As shown by a microwave-irradiating device 90 shown in FIG. 5 and microwave-irradiating devices 90A and 90B shown in FIG. 7, the microwave-irradiating device is an energy-supplying unit covering the endless-belt conveyer 66 and supplying energy on the paper.

The microwave-irradiating device is a device in a magnetron system. The magnetron system is a system converting direct current power into microwave by a vacuum tube. The microwave-irradiating device has a cylindrical anode having a cavity resonating with microwave at 2.45 GHz around a central cathode and a magnet applying a magnetic field vertically on these electrodes and generates a microwave from direct current in the magnetic field in the structure.

—Ink-Ejecting Processs c and d—

The ink-ejecting unit in the ink-ejecting process is not particularly limited, and any known ink-ejecting unit may be used. An example of favorable ink-ejecting unit will be described below with reference to the drawings.

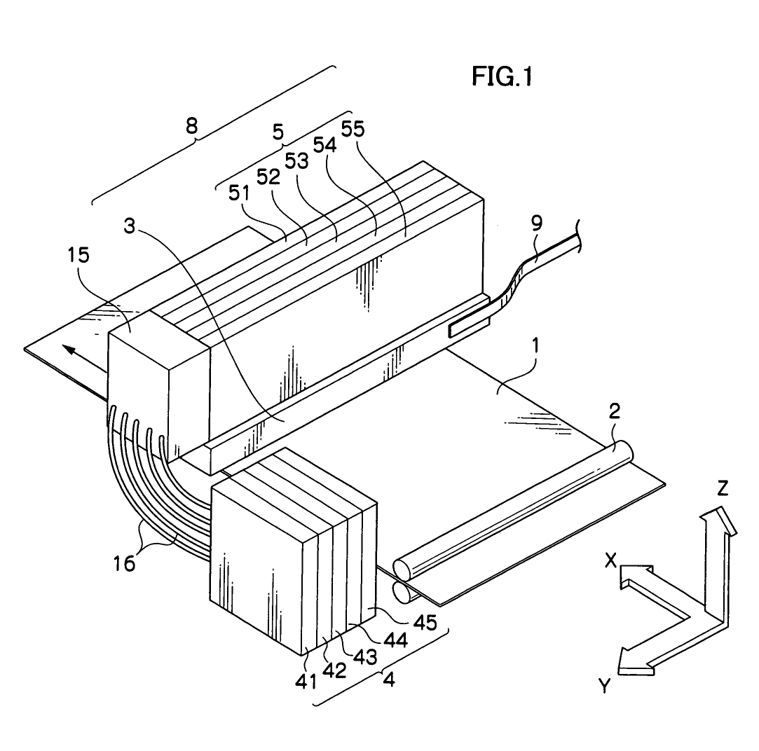

FIG. 1 is a perspective view illustrating an ink-ejecting unit. The ink-ejecting unit shown in FIG. 1 has a recording head 3 identical or larger in width than the recording medium (paper)1, a paper-feeding mechanism (conveyor roller 2 in the present exemplary embodiment, but may be, for example, a belt-shaped paper-feeding mechanism) feeding the paper in a slow scanning direction (paper 1—conveying direction: arrow X direction), an image-forming unit 8 (image-forming unit) forming an image on the surface of paper 1 by ejecting ink with the recording head 3, and a main ink tank unit 4 supplying ink to respective sub-ink tanks 5 in the image-forming unit 8.

Although not shown in the figure, as sub-ink tanks 51 to 55 are aligned in the slow scanning direction (paper 1—conveying direction: arrow X direction), nozzles ejecting inks in various colors are also aligned in the slow scanning direction.

The image-forming unit 8 forms an image on the surface of the paper 1 by ejecting ink. The image-forming unit 8 mainly contains the recording head 3, the sub-ink tank unit 5, and a power supply/signal cable 9.

The sub-ink tank unit 5 has the sub-ink tanks 51, 52, 53, 54, and 55 respectively containing inks different in color so that these inks can eject from the recording head. For example, black ink (K), yellow ink (Y), magenta ink (M), and cyan ink (C) are stored therein, as supplied from the main ink tank unit 4.

A replenishing apparatus 15 is connected to the main ink tank unit 4 through replenishing tubes 16, and ink is supplied from the main ink tank unit 4 through supply holes into the sub-ink tank unit 5 by the replenishing apparatus 15. Although the sub-ink tank unit 5 is always connected to the replenishing apparatus 15 in the configuration shown in the figure, it may be connected to the replenishing apparatus 15 only during ink supply.

The main ink tank unit 4 also has main ink tanks 41, 42, 43, 44, and 45 containing respective inks different in color. For example, black ink (K), yellow ink (Y), magenta ink (M), and cyan ink (C) are filled respectively in the tanks.

The power supply/signal cable 9 and the sub-ink tank 5 are connected to the recording head 3 each other. When external image recording information is inputted from the power supply/signal cable 9 to the recording head 3, the recording head 3 ejects predetermined amounts of inks from the respective sub-ink tanks 5 onto the surface of the recording medium, based on the image recording information. In addition to processing of the image recording information, the power supply/signal cable 9 also has a role to supply to the recording head 3 the power needed for driving the recording head 3.

For further improvement in curling resistance and stiffness, the amount of the polybasic acid according to the exemplary embodiment of the invention added to the paper is preferably adjusted to 0.03 to 5.6 g/m², more preferably to 0.1 to 2.2 g/m². The addition amount of the polybasic acid can be adjusted, by controlling the amount of the polybasic acid added to the processing solution or by controlling the amount of the polybasic acid added to the ink and the amount of the ink ejected.

—Image Recording Device—

Hereinafter, the image recording device according to the exemplary embodiment of the invention having these mechanisms will be described.

The image recording device in the first aspect of the invention characteristically has at least the following unit A) to C):

A) unit that supplies, onto one side or both sides of the recording medium (paper), a processing solution containing a polybasic acid having in the molecule two or more groups interactive with the paper components (processing solution-supplying unit);

B) unit that supplies energy to the recording medium (paper) (energy-supplying unit); and

C) unit that ejects ink from an ink-ejecting unit on the printing surface of the recording medium (paper) (ink-ejecting unit)

Hereinafter, an example of the image recording device according to the exemplary embodiment of the invention will be described with reference to the drawings. FIG. 4 is a schematic sectional view illustrating an example of the image recording device in the first aspect of the invention.

An image recording device 60 shown in FIG. 4 has a paper-feeding unit 62, an adsorption unit 64, endless-belt conveyers 66 and 68, a processing-solution recording head (processing solution-supplying unit) 70, a heating roller (energy-supplying unit) 72, ink-recording heads (ink-ejecting unit) 74, ink tanks 76, and a paper discharge unit 78.

As for the mechanism of the image recording device 60 shown in FIG. 4, the paper supplied from the paper-feeding unit 62 is fed in the direction indicated by an arrow A1 and adsorbed on the endless-belt conveyer 66 by the adsorption unit 64, and a processing solution is supplied on the paper by the processing-solution recording head 70. Then, the paper advances to the area in contact with the heating roller 72 (nip area) as driven by the endless-belt conveyer 66. Then, the paper is supplied with energy as it is heated by the heating roller 72 while pressed on the endless-belt conveyer 66, and the polybasic acid in the processing solution reacts with the paper components in crosslinking reaction. Then, the paper is transferred onto the endless-belt conveyer 68, and an image is formed by ejecting ink from the ink recording head 74. The image-formed paper advances to the direction indicated by an arrow A2 and is discharged into the paper discharge unit 78.

Hereinafter, an example of the image recording device according to the exemplary embodiment of the invention having a double-faced printing mechanism and a microwave-irradiating device as the energy-supplying unit will be described. FIG. 5 is a schematic sectional view illustrating an example of the image recording device according to the exemplary embodiment of the invention having a double-faced printing mechanism.

In an image recording device 80 shown in FIG. 5, an image is formed by a mechanism similar to that of the image recording device 60 shown in FIG. 4 during the period from paper feeding in the paper-feeding unit 62 to image formation by the ink recording head 74, except its energy-supplying method. The energy supply by the microwave-irradiating device 90 is performed by irradiating paper with microwave by the mechanism described above.

The paper that image is formed is transported in the direction indicated by arrows A2 and A3 to the position T. At the position T, the paper is then transported in the reverse direction indicated by arrows from B1 to B6 in this order, and an image is formed on the opposite side again. The paper that images are formed on both sides is transported in the direction indicated by arrows A2 and A3 and discharged into the paper discharge unit 78.

The image recording device in the first aspect of the invention, which has a processing solution-supplying unit, an energy-supplying unit, and an ink-ejecting unit as described above, is effective in preventing paper curling and improving paper stiffness, and thus in preventing trouble such as paper clogging, abrasion of image regions, and stacking trouble in a paper discharge unit significantly.

The image recording device in a second aspect of the invention characteristically has at least the following unit D) and E).

D) unit that ejects, onto the printing surface of the recording medium (paper), ink containing a polybasic acid having in the molecule two or more groups interactive with the paper components (ink-ejecting unit); and

E) unit that supplies energy to the recording medium (paper) (energy-supplying unit).

The image recording device according to the exemplary embodiment of the invention will be described with an example with reference to the drawing. FIG. 6 is a schematic sectional view illustrating an example of the image recording device in the second aspect of the invention.

An image recording device 100 shown in FIG. 6 has a paper-feeding unit 62, an adsorption unit 64, endless-belt conveyers 66 and 68, heating rollers (energy-supplying unit) 72A and 72B, recording heads (ink-ejecting unit) 74, ink tanks 76, and a paper discharge unit 78.

As for the mechanism of the image recording device 100 shown in FIG. 6, the paper supplied form the paper-feeding unit 62 is advanced in the direction indicated by an arrow A1, adsorbed on the endless-belt conveyer 66 by the adsorption unit 64, and supplied with energy, as it is pressed to the endless-belt conveyer 66 and heated by the heating roller 72A before ejection of ink from the recording head 74. Then, the paper is advanced onto the endless-belt conveyer 68. Ink is ejected on the paper from the recording head 74, and an image is formed. The paper that image is formed is transported to the area in contact with the heating roller 72B (nip area) as driven by the endless-belt conveyer 68, and is supplied with energy, as it is pressed onto the endless-belt conveyer 68 and heated by the heating roller 72B. By the energy supplied to the paper by the recording head 74 before and after ink ejection, the polybasic acid in the ink reacts with paper components in crosslinking reaction. The paper is then transported in the direction indicated by the arrow A2 and discharged into the paper discharge unit 78.

An example of the image recording device according to the exemplary embodiment of the invention having a double-faced printing mechanism and having a microwave-irradiating device as the energy-supplying unit will be described below. FIG. 7 is a schematic sectional view illustrating an example of the image recording device in the second aspect of the invention having a double-faced printing mechanism.

In an image recording device 120 shown in FIG. 7, an image is formed in a mechanism similar to that of the image recording device 100 shown in FIG. 6 during the period between paper feeding in the paper-feeding unit 62 and image formation by the recording head 74, except the energy-supplying method. The energy supply by microwave-irradiating devices 90A and 90B is performed by irradiating paper with microwave in the mechanism described above.

The paper that image is formed is transported to the position T in the direction indicated by arrows A2 and A3. At the position T, it is then transported in the reverse directions from B1 to B6 in this order, and an image is formed on the opposite side again. The paper that images are formed on both sides is transported in the direction indicated by arrows A2 and A3 and discharged into the paper discharge unit 78.

The image recording device in the second aspect of the invention, which has an ink-ejecting unit and an energy-supplying unit as described above, is effective in preventing paper curling and improving paper stiffness, and thus in preventing troubles such as paper clogging, abrasion of image regions, and stacking trouble in a paper discharge unit significantly.

### EXAMPLES

Hereinbelow, the exemplary embodiment of the invention will be described in detail by way of Examples. However, the exemplary embodiment of the invention is not limited to these Examples as long as the scope of the invention is not impaired. In the description of examples, unless otherwise specified, “parts” refers to parts by weight, and “%” unit % by weight.

### Example 1

### Preparation of Ink

A water-soluble organic solvent, a surfactant, an ion-exchange water are added to a colorant dispersion or a colorant-containing solution according to the following composition, to prepare a mixture containing respective materials at predetermined amounts, and the mixture is blended and agitated, and filtered through a 5 μm filter, to prepare an inkjet ink.

(Ink composition)

| | |
|---|---|
| C.I. Acid-Blue 9 | 3.5% |
| Diethylene glycol | 10% |
| Glycerin | 20% |
| Olfine E1010 | 1% |
| (manufactured by Nisshin | |
| Chemical Industry Co., Ltd.) | |
| Ion-exchange water | remaining amount |

—Preparation of Processing Solution A—

A mixture containing respective materials in predetermined amounts according to the following composition is prepared, and the mixture is blended and agitated, and filtered through a 5 μm filter, to prepare a polybasic acid (citric acid)-containing processing solution A.

(Composition of processing solution A)

| | |
|---|---|
| Citric acid | 15% |
| Diethylene glycol (DEG) | 5% |
| Glycerin (Gly) | 15% |
| 2-Pyrrolidone (2-pyr) | 2% |
| 1,2-Hexanediol | 1% |
| Olfine E1010 | 1% |
| (manufactured by Nisshin Chemical | |
| Industry Co., Ltd.) | |
| Sodium hydroxide (added to pH 3.5) | |
| Water | remaining amount |

<Printing Test>

A recording device shown in FIG. 4 (however, the processing solution-supplying method and the energy-supplying method are modified as shown in the following Tables 1 and 2) is used as the inkjet-recording apparatus, and ink is ejected by using a prototype paper-width line head of piezoelectric type (nozzle resolution: 800 dpi (number of dots per inch)). A removable heater unit shown in FIG. 2 is used as the energy-supplying unit. The energy-supplying method and processing solution-supplying method used are shown in the following Tables 1 and 2. The recording medium used in the printing test is A4-sized paper (210×297 mm, P Paper, manufactured by Fuji Xerox Office Supply Co., Ltd.).

The ink and the processing solution A above are used in the printing test, and the test is performed according to the following method:

First, the processing solution A is applied on the entire surface of the paper by roller coating method to attain a thickness of 1.1 g/m², and the paper is dried under heat by using a heater. Then, the ink is filled into the prototype line head, and an image is printed on the recording medium at a droplet quantity of 6 pL by controlling the waveform applied to the head (on the same face as when the processing solution A is applied). The printing is performed at a printing resolution of 800×800 dpi, and an image of 150 mm×200 mm in size is printed on the recording medium.

—Evaluation of Reverse Curling Immediately after Printing and Curling after Storage for 24 Hours—

The degree of curling is evaluated in the following manner: Results are shown in the following Tables 1 and 2. The paper is stored and conditioned under an environment of 23° C. and 50% RH for 24 hours before printing. The environment during printing and during storage after printing is 23° C. and 50% RH.

The reverse curling immediately after printing is evaluated by measuring the degree of paper deformation 15 seconds after completion of printing.

<Criteria for Curling Evaluation>

A: No deformation after storage

B: Almost no deformation after storage

C: Deformed but not rounded after storage

D: Mostly rounded after storage

Curling after storage for 24 hours is evaluated by measuring the degree of paper deformation 24 hours after completion of printing.

<Criteria for curling evaluation>

A: No deformation after storage

B: Almost no deformation after storage

C: Deformed but not rounded after storage

D: Mostly rounded after storage

### Example 2

Printing test is performed in a similar manner to Example 1, except that the composition of processing solution is changed to that shown in Table 1 (amount of 1,2-hexanediol is changed to 2%) and the processing solution is supplied onto both sides (both surfaces) of the recording medium. The amount of the processing solution coated is adjusted to be 0.4 g/m² on the printing side and 0.8 g/m² on the opposite side of the printing side.

### Example 3

Printing test is performed in a similar manner to Example 1, except that the composition of the processing solution is changed to that shown in Table 1, and the processing solution-supplying method is changed to the inkjet method (specifically, a prototype paper-width line head of the piezoelectric type (nozzle resolution: 800 dpi) that has a mechanism similar to that of the ink-ejection recording head). The processing solution is ejected on the entire surface of the ink printing side of the paper to attain a coating amount of 0.9 g/m².

### Example 4

Printing test is performed in a similar manner to Example 1, except that the polybasic acid is changed to 1,2,3,4-butanetetracarboxylic acid and the composition of the processing solution is changed to that shown in Table 1.

### Example 5

Printing test is performed in a similar manner to Example 1, except that the polybasic acid is changed to 1,2,3-propanetricarboxylic acid and the composition of the processing solution is changed to that shown in Table 1.

### Example 6

Printing test is performed in a similar manner to Example 1, except that the polybasic acid is changed to a mixture of citric acid and 1,2,3,4-butanetetracarboxylic acid and the composition of the processing solution is changed to that shown in Table 1.

### Example 7

Printing test is performed in a similar manner to Example 1, except that the composition of the processing solution is changed to that shown in Table 1 (amount of 1,2-hexanediol is changed to 2%), and heating for energy supply is performed twice after supply of processing solution (before ink printing) and after ink printing.

### Example 8

Printing test is performed in a similar manner to Example 1, except that the composition of the processing solution is changed to that shown in Table 2 (amount of 1,2-hexanediol is changed to 2%), and heating for energy supply is performed before supply of the processing solution.

### Example 9

Printing test is performed in a similar manner to Example 1, except that the composition of the processing solution is changed to that shown in Table 2 (amount of diethylene glycol is changed to 0%), and energy is supplied by the microwave-irradiating device shown in FIG. 3.

### Example 10

Printing test is performed in a similar manner to Example 1, except that the polybasic acid is changed to maleic acid and the composition of the processing solution is changed to that shown in Table 2.

### Example 11

Printing test is performed in a similar manner to Example 1, except that the composition of the processing solution is changed to that shown in Table 2 (amount of diethylene glycol is changed to 0%), 5% of a polybasic acid citric acid is added to the ink, and heating for energy supply is performed twice after supply of processing solution (before ink printing) and after ink printing.

### Comparative Example 1

Printing test is performed in a similar manner to Example 1, except that the polybasic acid is changed to acetic acid and the composition of the processing solution is changed to that shown in Table 2.

### Comparative Example 2

Printing test is performed in a similar manner to Example 1, except that the composition of the processing solution is changed to that shown in Table 2, and no energy is supplied.

The results above are shown in the following Tables 1 and 2. Abbreviations used in Tables 1 and 2 are as follows:

DEG: Diethylene glycol

Gly: Glycerol

2-pyr: 2-Pyrrolidone

BCBT: Butyl carbitol

E1010: Olfine E1010 (manufactured by Nisshin Chemical Industry Co., Ltd.)

TABLE 1

| | | Example 1 | Example 2 | Example 3 | Example 4 | Example 5 | Example 6 | Example 7 |
|---|---|---|---|---|---|---|---|---|
| Processing | Citric acid | 15% | 15% | 10% | | | 8% | 15% |
| solution | 1,2,3,4-Butanetetra | | | | 10% | | 2% | |
| composition | carboxylic acid | | | | | | | |
| | 1,2,3-Propanetri | | | | | 10% | | |
| | carboxylic acid | | | | | | | |
| | Maleic acid | | | | | | | |
| | Acetic acid | | | | | | | |
| | DEG | 5% | 5% | 10% | 15% | 15% | 15% | 5% |
| | Gly | 15% | 15% | 15% | 5% | 5% | 5% | 15% |
| | 2-pyr | 2% | 2% | 1% | 1% | | 1% | 2% |
| | 1,2-Hexanediol | 1% | 2% | 1% | 0.5% | 1% | 0.5% | 2% |
| | BCBT | | | | 2% | | 2% | |
| | E1010 | 1% | 1% | 1.5% | 1% | 1.5% | 0.75% | 1% |
| | Sodium hydroxide | Added to pH 3.5 | Added to pH 3.5 | Added to | 0.3% | 0.3% | 0.3% | Added to |
| | | | | pH 3.5 | | | | pH 3.5 |
| | Water | remaining | remaining | remaining | remaining | remaining | remaining | remaining |
| | | amount | amount | amount | amount | amount | amount | amount |

| | | | | | | | |
|---|---|---|---|---|---|---|---|
| Method of supplying processing | Roller coating | Roller coating | Inkjet coating | Roller | Roller | Roller | Roller coating |
| solution | | (both surfaces) | | coating | coating | coating | |
| Method of supplying energy | Heated after | Heated after | Heated after | Heated after | Heated after | Heated after | Heated (1) after |
| | supply of | supply of | supply of | supply of | supply of | supply of | supply of |
| | processing | processing | processing | processing | processing | processing | processing |
| | solution | solution | solution | solution | solution | solution | solution and (2) |
| | | | | | | | after ink |
| | | | | | | | printing |
| Reverse curling | B | B | B | B | B | B | B |
| immediately after printing | | | | | | | |
| Curling after storage for 24 hours | B | A | B | B | B | B | B |

TABLE 2

| | | | | | | Comparative | Comparative |
|---|---|---|---|---|---|---|---|
| | | Example 8 | Example 9 | Example 10 | Example 11 | Example 1 | Example 2 |
| Processing | Citric acid | 15% | 15% | | 15% | | 15% |
| solution | 1,2,3,4-Butanetetra | | | | | | |
| composition | carboxylic acid | | | | | | |
| | 1,2,3-Propanetri | | | | | | |
| | carboxylic acid | | | | | | |
| | Maleic acid | | | 15% | | | |
| | Acetic acid | | | | | 15% | |
| | DEG | 5% | | | | 15% | 15% |
| | Gly | 15% | 15% | 15% | 15% | | |
| | 2-pyr | 2% | 2% | 2% | 2% | 2% | 2% |
| | 1,2-Hexanediol | 2% | 1% | 1% | 1% | 2% | 2% |
| | BCBT | | | | | | |
| | E1010 | 1% | 1% | 1% | 1% | 1% | 1% |
| | Sodium hydroxide | Added to pH 3.5 | Added to pH 3.5 | Added to pH 3.5 | Added to pH 3.5 | 0.3% | Added to pH 4.3 |
| | Water | remaining | remaining | remaining | remaining | remaining | remaining |
| | | amount | amount | amount | amount | amount | amount |

| | | | | | | |
|---|---|---|---|---|---|---|
| Method of supplying processing | Roller coating | Roller coating | Roller coating | Roller coating | Roller coating | Roller coating |
| solution | | | | | | |
| Method of supplying energy | Heated before | microwave- | Heated after | Heated (1) after | Heated after | None |
| | supply of | irradiated after | supply of | supply of | supply of | |
| | processing | supply of | processing | processing | processing | |
| | solution | processing | solution | solution and (2) | solution | |
| | | solution | | after ink | | |
| | | | | printing | | |
| Reverse curling | C-B | B | B | B | D | D |
| immediately after printing | | | | | | |
| Curling after storage for 24 hours | B | B | B | B | D | C |

### Example 12

### Preparation of Ink

A water-soluble organic solvent, a surfactant, and ion-exchange water are added to a colorant dispersion or a colorant-containing solution according to the following composition, to prepare a mixture containing respective materials in predetermined amounts, and the mixture is blended and agitated and filtered through a 5 μm filter, to prepare an inkjet ink A containing a polybasic acid (citric acid).

(Composition of inkjet ink A)

| | |
|---|---|
| Citric acid | 4% |
| Cabojet-200 (manufactured by Cabot Corporation) | 2.5% |
| Diethylene glycol | 10% |
| Glycerin | 20% |
| Olfine E1010 | 1% |
| (manufactured by Nisshin Chemical Industry Co., Ltd.) | |
| Ion-exchange water | remaining |
| | amount |

<Printing Test>

The ink is printed by using a recording device shown in FIG. 6 (however, the energy-supplying method is modified as shown in the following Tables 3 and 4) as the inkjet-recording apparatus and a prototype paper-width line head of the piezoelectric type (nozzle resolution: 800 dpi (number of dots per inch)). A removable heater unit shown in FIG. 2 is used as the energy-supplying unit. The method of supplying energy is shown in the following Tables 3 and 4. A4 paper (210×297 mm, P Paper, manufactured by Fuji Xerox Office Supply Co., Ltd.) is used as the recording medium in the printing test.

The printing test is performed with the ink A, according to the following method:

The ink A is filled into the prototype line head, and printing is performed on the recording medium while the waveform applied to the head is adjusted to a droplet ejection quantity of 6 μL.

—Evaluation of Curling after Printing—

The degree of curling is evaluated according to the following method. Results are shown in the following Tables 3 and 4.

Evaluation of the curl is determined by printing an image of 150 mm×200 mm in size on the recording medium at an ink droplet of 6 μL and a printing resolution of 800×800 dpi and by measuring the degree of paper deformation of the paper 24 hours after completion of printing. The paper is stored and conditioned under an environment of 23° C. and 50% RH for 24 hours before printing. The environment during printing and during storage after printing is 23° C. and 50% RH.

<Criteria for Curling Evaluation>

A: Almost no deformation after storage

B: Some deformation after storage but no rounding

C: Mostly rounded after storage

### Example 13

Printing test is performed in a similar manner to Example 12, except that the ink used is changed to the following ink B.

(Composition of inkjet ink B)

| | |
|---|---|
| Citric acid | 5% |
| C.I. Acid Blue 9 | 2.5% |
| Diethylene glycol | 15% |
| Glycerin | 20% |
| Olfine E1010 | 1% |
| (manufactured by Nisshin Chemical | |
| Industry Co., Ltd.) | |
| Ion-exchange water | remaining amount |

### Example 14

Printing test is performed in a similar manner to Example 12, except that the ink used is changed to the following ink C and heating for energy supply is performed before and after printing.

(Composition of inkjet ink C)

| | |
|---|---|
| Citric acid | 3.5% |
| Carbon black Raven 1080 | 1.5% |
| (manufactured by Columbian Carbon Co., Ltd.) | |
| Styrene-acrylic acid copolymer (dispersant) | 0.5% |
| Diethylene glycol | 15% |
| Glycerin | 20% |
| Olfine E1010 | 1% |
| (manufactured by Nisshin Chemical Industry Co., Ltd.) | |
| Ion-exchange water | remaining |
| | amount |

### Example 15

Printing test is performed in a similar manner to Example 12, except that the ink used is changed to the following ink D.

(Composition of inkjet ink D)

| | |
|---|---|
| Citric acid | 3.5% |
| Self-dispersible pigment dispersion | 3.0% |
| (cationic pigment, IJX-253, manufactured by | |
| Cabot Corporation) | |
| Propylene glycol | 10% |
| Glycerin | 20% |
| Olfine E1010 | 1% |
| (manufactured by Nisshin Chemical | |
| Industry Co., Ltd.) | |
| Ion-exchange water | remaining amount |

### Example 16

Printing test is performed in a similar manner to Example 12, except that the ink used is changed to the following ink E, and the heating for energy supply is performed before and after printing.

(Composition of inkjet ink E)

| | |
|---|---|
| 1,2,3,4-Butanetetracarboxylic acid | 3.0% |
| C.I. Acid Blue 9 | 2.5% |
| Propylene glycol | 10% |
| Glycerin | 20% |
| Olfine E1010 | 1% |
| (manufactured by Nisshin Chemical | |
| Industry Co., Ltd.) | |
| Ion-exchange water | remaining amount |

### Example 17

Printing test is performed in a similar manner to Example 12, except that the ink used is changed to the following ink F.

(Composition of inkjet ink F)

| | |
|---|---|
| 1,2,3-Propanetricarboxylic acid | 2.5% |
| C.I. Direct Blue 199 | 2.5% |
| Propylene glycol | 5% |
| Glycerin | 25% |
| Olfine E1010 | 1% |
| (manufactured by Nisshin Chemical | |
| Industry Co., Ltd.) | |
| Ion-exchange water | remaining amount |

### Example 18

Printing test is performed in a similar manner to Example 12, except that the ink used is changed to the following ink G

(Composition of inkjet ink G)

| | |
|---|---|
| Citric acid | 2.0% |
| Self-dispersible pigment dispersion | 3.0% |
| (cationic pigment, IJX-253, manufactured | |
| by Cabot Corporation) | |
| Propylene glycol | 10% |
| Glycerin | 20% |
| Olfine E1010 | 1% |
| (manufactured by Nisshin Chemical | |
| Industry Co., Ltd.) | |
| Ion-exchange water | remaining amount |

### Example 19

Printing test is performed in a similar manner to Example 12, except that the ink used is changed to the following ink H.

(Composition of inkjet ink H)

| | |
|---|---|
| Citric acid | 5.0% |
| Self-dispersible pigment dispersion | 3.0% |
| (cationic pigment, IJX-253, manufactured | |
| by Cabot Corporation) | |
| Propylene glycol | 10% |
| Glycerin | 20% |
| Olfine E1010 | 1% |
| (manufactured by Nisshin Chemical | |
| Industry Co., Ltd.) | |
| Ion-exchange water | remaining amount |

### Example 20

Printing test is performed in a similar manner to Example 12, except that the ink used is changed to the following ink I.

(Composition of inkjet ink I)

| | |
|---|---|
| Citric acid | 2.0% |
| Carbon black Raven 1080 | 1.5% |
| (manufactured by Columbian Carbon Co., Ltd.) | |
| Styrene-acrylic acid copolymer (dispersant) | 0.5% |
| Diethylene glycol | 15% |
| Glycerin | 20% |
| Olfine E1010 | 1% |
| (manufactured by Nisshin Chemical | |
| Industry Co., Ltd.) | |
| Ion-exchange water | remaining |
| | amount |

### Example 21

Printing test is performed in a similar manner to Example 12, except that the ink used is changed to the following ink J.

(Composition of inkjet ink J)

| | |
|---|---|
| Citric acid | 7.0% |
| Dye (AR52) | 2.0% |
| Diethylene glycol | 15% |
| Glycerin | 20% |
| Olfine E1010 | 1% |
| (manufactured by Nisshin Chemical | |
| Industry Co., Ltd.) | |
| Ion-exchange water | remaining amount |

### Example 22

Printing test is performed in a similar manner to Example 13, except that heating for energy supply is performed only before printing.

### Example 23

Printing test is performed in a similar manner to Example 13, except that the energy-supplying unit is changed to the microwave-irradiating device shown in FIG. 3.

### Example 24

Printing test is performed in a similar manner to Example 12, except that the ink used is changed to the following ink K.

(Composition of inkjet ink K)

| | |
|---|---|
| Maleic acid | 4.0% |
| C.I. Acid Blue 9 | 2.5% |
| Diethylene glycol | 10% |
| Glycerin | 20% |
| Olfine E1010 | 1% |
| (manufactured by Nisshin Chemical | |
| Industry Co., Ltd.) | |
| Ion-exchange water | remaining amount |

### Comparative Example 3

Printing test is performed in a similar manner to Example 13, except that the heater unit used as the energy-supplying unit is removed.

### Comparative Example 4

Printing test is performed in a similar manner to Example 12, except that the ink used is changed to the following ink L.

(Composition of inkjet ink L)

| | |
|---|---|
| Acetic acid | 5% |
| C.I. Acid Blue 9 | 2.5% |
| Diethylene glycol | 15% |
| Glycerin | 20% |
| Olfine E1010 | 1% |
| (manufactured by Nisshin Chemical | |
| Industry Co., Ltd.) | |
| Ion-exchange water | remaining amount |

### Comparative Example 5

Printing test is performed in a similar manner to Example 12, except that the ink used is changed to the following ink M.

(Composition of inkjet ink M)

| | |
|---|---|
| Pyrrolidonecarboxylic acid | 3.5% |
| C.I. Acid Blue 9 | 2.5% |
| Diethylene glycol | 15% |
| Glycerin | 20% |
| Olfine E1010 | 1% |
| (manufactured by Nisshin Chemical | |
| Industry Co., Ltd.) | |
| Ion-exchange water | remaining amount |

The results above and others are shown in the following Tables 3 and 4.

TABLE 3

| | Colorant | | Polybasic acid | | | |
|---|---|---|---|---|---|---|
| | | Addition | | Addition | Method of | |
| | | amount % | | amount % | supplying energy | Curling |
| Example 12 | Self-dispersible | 2.5% | Citric acid | 4.0% | Heated after printing | A |
| | pigment (sulfonic | | | | | |
| | acid-based) | | | | | |
| Example 13 | Dye (AB9) | 2.5% | Citric acid | 5.0% | Heated after printing | A |
| Example 14 | Resin dispersion | 1.5% | Citric acid | 3.5% | Heated before and | A |
| | pigment (sulfonic | | | | after printing | |
| | acid-based) | | | | | |
| Example 15 | Cationic pigment | 3.0% | Citric acid | 3.5% | Heated after printing | A |
| Example 16 | Dye (AB9) | 2.5% | 1,2,3,4-Butanetetra | 3.0% | Heated before and | A |
| | | | carboxylic acid | | after printing | |
| Example 17 | Dye (DB199) | 2.5% | 1,2,3-Propanetri | 2.5% | Heated after printing | B |
| | | | carboxylic acid | | | |
| Example 18 | Cationic pigment | 3.0% | Citric acid | 2.0% | Heated after printing | B |
| Example 19 | Cationic pigment | 3.0% | Citric acid | 5.0% | Heated after printing | A |
| Example 20 | Resin dispersion | 1.5% | Citric acid | 2.0% | Heated after printing | B |
| | pigment (sulfonic | | | | | |
| | acid-based) | | | | | |
| Example 21 | Dye (AR52) | 2.0% | Citric acid | 7.0% | Heated after printing | A |

TABLE 4

| | Colorant | | Polybasic acid | | | |
|---|---|---|---|---|---|---|
| | | Addition | | Addition | Method of | |
| | | amount % | | amount % | supplying energy | Curling |
| Example 22 | Dye (AB9) | 2.5% | Citric acid | 5.0% | Heated before | B |
| | | | | | printing | |
| Example 23 | Dye (AB9) | 2.5% | Citric acid | 5.0% | microwave- | A |
| | | | | | irradiated after | |
| | | | | | printing | |
| Example 24 | Dye (AB9) | 2.5% | Maleic acid | 4.0% | Heated after printing | B |
| Comparative | Dye (AB9) | 2.5% | Citric acid | 4.0% | None | C |
| Example 3 | | | | | | |
| Comparative | Dye (AB9) | 2.5% | Acetic acid | 5.0% | Heated after printing | C |
| Example 4 | | | | | | |
| Comparative | Dye (AB9) | 2.5% | Pyrrolidone | 3.5% | Heated after printing | C |
| Example 5 | | | carboxylic acid | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An image recording device, comprising:
a processing solution-supplying unit that supplies, to a recording medium, a processing solution containing a polybasic acid having in a molecule two or more groups reactive with a component of the recording medium;
an ink-ejecting unit that ejects ink to the recording medium; and
an energy supplying unit that supplies energy to the recording medium.

2. An image recording device, comprising:
an ink-ejecting unit that ejects, onto a recording medium, an ink containing a colorant and a polybasic acid having in a molecule two or more groups reactive with a component of the recording medium; and
an energy supplying unit that supplies energy to the recording medium.

3. The image recording device according to claim 1, wherein
the component of the recording medium has a hydroxyl group, and
the polybasic acid has in the molecule two or more groups interactive by a hydrogen-bonding force, or chemically reactive with a hydroxyl group.

4. The image recording device according to claim 3, wherein the polybasic acid has two or more carboxyl or hydroxyl groups in the molecule.

5. The image recording device according to claim 4, wherein the polybasic acid has three or more carboxyl groups in the molecule.

6. The image recording device according to claim 2, wherein
the component of the recording medium has a hydroxyl group, and
the polybasic acid has in the molecule two or more groups interactive by a hydrogen-bonding force, or chemically reactive with a hydroxyl group.

7. The image recording device according to claim 6, wherein the polybasic acid has two or more carboxyl or hydroxyl groups in the molecule.

8. The image recording device according to claim 7, wherein the polybasic acid has three or more carboxyl groups in the molecule.

9. The image recording device according to claim 1, wherein the polybasic acid is at least one selected from the group consisting of citric acid, 1,2,3,4-butanetetracarboxylic acid, 1,2,3-propanetricarboxylic acid, oxydisuccinic acid, tartrate disuccinic acid, carboxyethylthiosuccinic acid, carboxymethylthiosuccinic acid, maleic acid, fumaric acid, and polycarboxylate polymers.

10. The image recording device according to claim 2, wherein the polybasic acid is at least one selected from the group consisting of citric acid, 1,2,3,4-butanetetracarboxylic acid, 1,2,3-propanetricarboxylic acid, oxydisuccinic acid, tartrate disuccinic acid, carboxyethylthiosuccinic acid, carboxymethylthiosuccinic acid, maleic acid, fumaric acid, and polycarboxylate polymers.

11. The image recording device according to claim 1, wherein the processing solution-supplying unit uses at least one coating method selected from the group consisting of inkjet coating, roller coating, blade coating, screen coating and spray coating.

12. The image recording device according to claim 1, wherein the energy-supplying unit supplies an electromagnetic wave.

13. The image recording device according to claim 12, wherein the energy-supplying unit supplies at least one of a microwave and a high-frequency wave.

14. The image recording device according to claim 2, wherein the energy-supplying unit supplies an electromagnetic wave.

15. The image recording device according to claim 14, wherein the energy-supplying unit supplies at least one of a microwave and a high-frequency wave.

16. An image recording method, comprising:
supplying, to a recording medium, a processing solution containing a polybasic acid having in a molecule two or more groups reactive with a component of the recording medium;
ejecting ink onto the recording medium; and
supplying energy to the recording medium.

17. An image recording method, comprising:
ejecting, onto a recording medium, an ink containing a colorant and a polybasic acid having in a molecule two or more groups reactive with a component of the recording medium; and
supplying energy to the recording medium.

18. The image recording method according to claim 16, wherein the energy is supplied after the processing solution is supplied and the ink is ejected after the energy is supplied.

19. The image recording method according to claim 17, wherein the energy is supplied after the ink is supplied.
